(19) United States
(12) Patent Application Publication
(10) Pub. No.: US 2023/0243301 A1
(43) Pub. Date: Aug. 3, 2023

(54) ZERO EMISSION POWER GENERATION SYSTEMS AND METHODS

(71) Applicant: Industriasys Corp., Oakville (CA)

(72) Inventors: Lorenzo Jose Castro Escobal, Oakville (CA); Michail Georgakis, Oakville (CA); Edward J. Green, Oakville (CA)

(21) Appl. No.: 17/936,054

(22) Filed: Sep. 28, 2022

Related U.S. Application Data
(63) Continuation of application No. PCT/CA2022/050125, filed on Jan. 28, 2022.

(51) Int. Cl. F02C 6/18; F01N 5/02

(52) U.S. Cl. CPC F02C 6/18; F01N 5/02; F05D 2220/72

(57) ABSTRACT

Oxy-fuel combustion of a fuel stream, an oxygen stream and a recycle stream can form an exhaust stream, with, for example, a gas turbine. The exhaust stream can be separated into a water-rich stream and a carbon dioxide-rich stream. At least a portion of the carbon dioxide-rich stream can be divided to form the recycle stream. A second portion of the carbon dioxide-rich stream and a hydrogen stream can generate an exit stream, with, for example, a Sabatier reactor. The exit stream can be separated into a methane-rich gaseous product and a water-rich liquid product.

### CROSS-REFERENCE TO RELATED APPLICATIONS

This is a continuation of International Application No. PCT/CA2022/050125 filed on Jan. 28, 2022, which claims priority to United States Provisional Application No. 63/143,406 filed on Jan. 29, 2021, and the entire contents of each are hereby incorporated herein by reference.

### FIELD

The present disclosure relates generally to power generation involving oxy-fuel combustion.

### INTRODUCTION

The following paragraphs are not an admission that anything discussed in them is prior art or part of the knowledge of persons skilled in the art.

Power plants using fossil fuels create large amounts of carbon dioxide emissions. Various technologies have been employed for the removal of carbon dioxide from atmospheric air, including adsorption on solid adsorbents, membrane separation, liquid based absorption (for example, with amines), and pre-combustion capture methodologies. Each of those exhibits advantages and disadvantages and can raise the cost of electricity generation. The first three approaches can be termed as post-combustion, as opposed to pre-combustion approaches. Pre-combustion approaches are based on the actual separation of carbon content before combustion of the fuel, while the post combustion processes aim at removing carbon dioxide composition from flue gases. Pre-combustion approaches tend to be more expensive for the case of existing plants (i.e. retrofitting).

Carbon dioxide removal becomes troublesome mainly due to the low concentrations that it is found in flue gases, and secondly due to the complex composition of this mixture. Having a lower number of components and higher compositions of carbon dioxide in the flue gases can simplify its capture and removal.

Besides carbon dioxide emissions, SOx and NOx emissions can be a pollution issue for power plants. Depending mainly on the fuel, such emissions can vary. NOx in particular can be a harsher pollutant in the atmosphere and lead to severe degradation of atmospheric air and environment. Ozone gas is undesirably formed in the lower layers of the atmosphere, with negative effects on human health. SOx emissions can contribute to acidic rain and cause irreversible damages to health and infrastructure.

Oxy-combustion involves combusting carbon containing fuels with pure oxygen to minimize NOx emissions and reduce carbon dioxide separation costs from combustion gases. Oxy-fuel combustion processes require an atmospheric air separation process that can include pressure swing adsorption (PSA), which is preferred for low production rates, and cryogenic distillation, which is preferred for high production rates. Separating air into mainly oxygen and nitrogen comes with a cost that can be covered by gains in the carbon dioxide separation processes. Separated nitrogen is a valuable byproduct of the air separation process. The purity of oxygen that is produced by these separations can be up to 99.99%, but purities above 95% are desired and can be acceptable. The cost of purifying oxygen from 95% to higher concentrations increases rapidly and is an optimization point of such processes. Cryogenic distillation currently has significant advantages over PSA but also over approaches such as water electrolysis for co-generation of hydrogen and oxygen.

Pollution from waste in landfills can be reduced by processes that produce biofuels from that waste. Such processes can involve gasification of the waste and produce gaseous fuels that are rich in hydrogen, carbon monoxide, carbon dioxide and methane. Solid byproducts of lower value are also produced.

Oxygen-based combustion produces higher temperatures than air-based combustion, since the nitrogen content is missing in the oxygen-based processes. This can allow for higher temperatures at the inlet of gas turbines, and higher temperatures at the exit of gas turbines. The first point can result in higher gas turbines efficiency, and the second point can result in higher steam turbine efficiency, which are both desired for electricity generation reasons. However, there are material limitations to both, since the higher temperatures of flowing fluids limit those temperature increases at turbine inlets and outlets. Advances in turbines and heat exchanger manufacturing technologies, and their materials of manufacture, can make the use of oxy-fuel combustion a scalable approach for higher achieved efficiencies. The oxy-fuel approach can also eliminate NOx production through the removal of nitrogen at the air separation unit (ASU). Without the removal of nitrogen, the higher temperatures would lead to higher NOx generation (i.e. thermal NOx). Thus, oxy-fuel combustion can lead to elimination of NOx, capture of carbon dioxide, and high efficiencies for the power plant.

Carbon dioxide in oxy-fuel approaches can be separated and removed from combustion gases due to the high composition and an almost binary mixture case. A condensation step can be sufficient to provide separation between water and carbon dioxide, as they can be the only two components of the mixture. In some cases, a further purification step can be used based on the amine absorption.

### BRIEF DESCRIPTION OF THE DRAWINGS

The drawings included herewith are for illustrating various examples of apparatuses and methods of the present disclosure and are not intended to limit the scope of what is taught in any way.

FIG. 1 is a schematic flow diagram of an example of a power generation system including a gas turbine, a closed supercritical steam turbine cycle, and separation and pipelining of produced carbon dioxide.

FIG. 2 is a schematic flow diagram of an example of a power generation system including a gas turbine, a closed supercritical steam turbine cycle, a Sabatier reactor with an electrolysis cell for hydrogen production, and methane production and storage.

FIGS. 3A and 3B are schematic flow diagrams of an example of a power generation system including two gas turbines, two supercritical steam turbine cycles, a Sabatier reactor with an electrolysis cell for hydrogen production, and combustion of produced methane in the second gas turbine, with carbon dioxide compressed and pipelined.

### DETAILED DESCRIPTION

Various apparatuses or methods will be described below to provide an example of an embodiment of each claimed invention. No embodiment described below limits any claimed invention and any claimed invention may cover apparatuses and methods that differ from those described below. The claimed inventions are not limited to apparatuses and methods having all of the features of any one apparatus or method described below, or to features common to multiple or all of the apparatuses or methods described below. It is possible that an apparatus or method described below is not an embodiment of any claimed invention. Any invention disclosed in an apparatus or method described below that is not claimed in this document may be the subject matter of another protective instrument, for example, a continuing patent application, and the applicant(s), inventor(s) and/or owner(s) do not intend to abandon, disclaim or dedicate to the public any such invention by its disclosure in this document.

Power generation systems and methods are presented herein, which can run on commercial fuel and/or biofuel resulting from waste gasification processes. The power generation can operate with pure oxygen (oxy-fuel combustion) and can remove up to 100% of carbon dioxide emissions via low cost, low complexity processes. In some examples, a portion of these carbon dioxide captured emissions can be transformed to methane, to be re-burnt, and the rest can be compressed and sent to a pipeline. In some examples, the total carbon dioxide captured emissions can be compressed and sent to a pipeline or to manufacturing of other products. Energy generation can be achieved by modified gas turbines and supercritical steam turbines. Carbon dioxide can be removed as compressed liquid for various uses. The described systems and methods can offer high efficiency along with complete carbon dioxide capture and elimination of NOx emissions. The described systems and methods can use renewable thermal loads and electricity to produce green hydrogen for internal use.

Power systems and methods can capture the total of its carbon dioxide emissions via an oxy-fuel, closed loops approach. In some examples, an atmospheric air separation unit can be used, with one gas turbine, a supercritical steam cycle, a condenser, and a compressor for the removed CO₂. In some examples, the power systems and methods can include use of an air separation unit, two gas turbines, two condensers for CO₂ removal, several supercritical steam turbines, a Sabatier reactor, and an electrolysis unit. In some examples, the power systems and methods can include use of an air separation unit, two gas turbines, several supercritical steam turbines, and a Sabatier reactor.

In some examples, the air separation unit can be a cryogenic distillation unit. Oxygen, nitrogen, and argon can be separated by distillation at very low temperatures. Oxygen can be provided in the range 95-99.9% purity. In some examples, the oxygen stream can be about 96% pure. In some examples, the oxygen stream can be about 97% pure. In some examples, the oxygen stream can be about 98% pure. In some examples, the oxygen stream can be about 99% pure. In some examples, the oxygen stream can be about 99.5% pure. In some examples, unless the oxygen stream has a purity of about 99.5% or more, there can be an accumulation of nitrogen in the system, in some case up to about 11%. This can result in the formation of NOx, although it can be much lower than in the case of air combustion.

Nitrogen is a valuable byproduct, which can be stored and sold, or used onsite, e.g. to produce salts and fertilizers. In some examples, oxygen can be produced via high-temperature steam electrolysis that also produces the necessary hydrogen for the process. Cryogenic distillation can be preferred over other approaches due to the advantages of scale and cost. If abundant renewable electricity is available, high-temperature steam electrolysis can also be employed to generate/cogenerate oxygen for the combustion of fuel.

The produced oxygen can contain a low composition of argon. In some examples, the oxygen is used in a first gas turbine after initial vaporization from the cryogenic distillation liquid state and subsequent compression, mixed with primary fuel. Diffusion and mixing requirements, including excess range, are different compared to air combustion examples.

The primary fuel for the power generation systems and methods can come from waste gasification, which can be rich in hydrogen, carbon monoxide, carbon dioxide and methane, in compositions of, for example and not intended to be limiting, 0-70%, 0-15%, 0-30% and 0-70%, respectively. However, in other examples, the systems and methods may operate with different gases, besides the biofuels with these compositions. In some examples, the fuels can include methane and a mixture of hydrocarbons. In some examples, the fuels can include commercially available fuels.

Combustion in the combustion chamber of the gas turbines can require a temperature decrease, since oxy-fuel combustion can lead to temperatures that manufacturing materials cannot handle. Thus, in some examples, a recycle stream is used that conveys CO₂ as a working fluid. In some examples, a recycle stream conveys a CO₂/H₂O mixture as a working fluid. The working fluid can be directed into the compressor at low temperatures for energy consumption decrease, and for temperature reduction in the combustion chamber. The recycle ratio is an optimization factor for the turbine efficiency’s maximization.

In some examples, the gas turbine powers a generator that produces electricity. The turbine exit stream can include carbon dioxide and water at high temperature. In some examples, this stream can be used in a closed loop supercritical steam cycle to produce additional electricity.

In some examples, the stream continues to a condenser, where it is cooled and can be separated into a water-rich stream and a carbon dioxide-rich stream. The water stream can be further used in condensers within the system. The carbon dioxide stream can be divided into two parts: the recycle stream to be directed to the gas turbine; and the remainder can be compressed and stored or pipelined, and/or, in some examples, directed to a Sabatier reactor for methanization.

In examples where the carbon dioxide is compressed and stored/ pipelined, the compressor can use a part of the electricity produced by the gas turbine’s generator. In examples where ultra-pure carbon dioxide is required, an additional amine-based scrubber can be used. In some examples, a mixture of monoethanolamine (MEA) and diethanolamine (DEA) in an aqueous solution can be used. In some examples, MEA can be used. In some examples, a mixture of MEA with a tertiary amine can be used. Various configurations are possible.

In examples where the carbon dioxide is directed to the Sabatier reactor, the carbon dioxide stream can be mixed and reacted catalytically with hydrogen to produce methane and water at 450° C. (Equation 1):

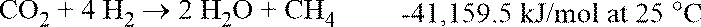

The products of the Sabatier reaction can be split into a recycle stream and a main product stream. The main product stream can be further separated via condensation into a water stream and a gaseous stream. The water can be further used in condensers and/or other applications.

In some examples, the Sabatier reactor can serve as a means to capture and transform carbon dioxide from coming from the first gas turbine. Thus, methanization can lead to the production of a valuable product for another combustion step, and/or its storage as a product. In some examples, the Sabatier reactor can be employed to produce recycled methane with a lower carbon footprint. This methane can be purified via an amine scrubber for the removal of acidic (carbon dioxide) traces and is sent to a pipeline.

In some examples, the main gaseous stream from the Sabatier reactor can be directed to a second gas turbine. A cooled gaseous stream, pure oxygen from the air separation unit, and a recycle stream can enter the second gas turbine in a similar manner to that of the first gas turbine. In some examples, the recycle stream can be carbon dioxide, and, in some examples, a carbon dioxide / water mixture. The second gas turbine can power a generator to produce electricity. The recycle stream can be a controlling and optimization parameter for the combustion and the second gas turbine’s efficiency.

After the second gas turbine, the exhaust gases can be carbon dioxide and water, and they can be directed to power a second supercritical steam turbine closed loop.

In some examples, a condensation step can follow that allows for carbon dioxide / water separation. The water can be further used in condensers or other applications. The carbon dioxide can be pressurized and pipelined/removed from the system. If very pure carbon dioxide is required, the stream can be purified in the amine scrubber. In some examples, the compressor can use a portion of the energy generated from the second gas turbine.

In examples that use the Sabatier reactor, hydrogen can be required at four times a molar amount that carbon dioxide is produced by the first gas turbine’s combustion chamber (excluding the recycle stream of the first gas turbine). The hydrogen can be produced via an electrolytic approach and/or other methods, with an emphasis on green origin.

In some examples, hydrogen can be produced via high-temperature steam electrolysis, at temperatures higher than 600° C. High-temperature electrolysis can have a high energetic cost, which can be broken down into thermal and electrical parts. When the temperature of the electrolysis is increased from 200 to 900° C., the thermal part can be as high as 27-29% and thus the electrical part is reduced. The total of the thermal load is provided by heat integration in the plant. Solid oxide fuel cells can be used, with efficiencies around 90% for this electrolytical process. In some examples, all the thermal load can come from nearby solar or nuclear plants. In some examples, electricity for the electrolytic process can come from surplus production of nearby renewable energy resources (e.g., solar, wind and/or wave). Thus, the systems and methods herein can function as a battery during low-demand times for renewable electricity producers.

Reference is now made to the following specific examples of the present disclosure, which are intended to be illustrative but non-limiting.

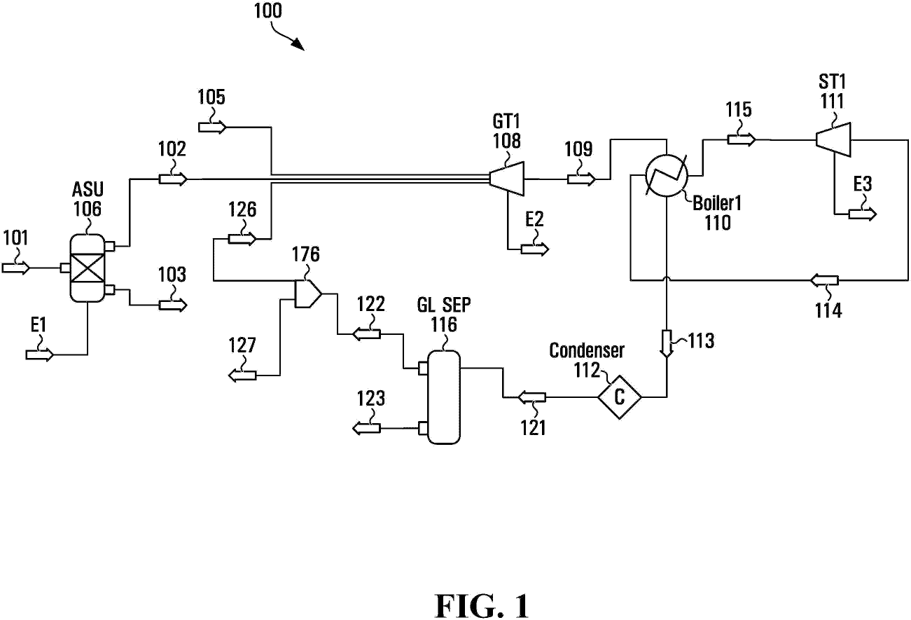

Referring to FIG. 1, a power generation system is shown generally at reference numeral 100.

In the example illustrated, atmospheric air 101 enters an air separation unit (ASU) 106, which can use cryogenic distillation to generate an oxygen stream 102 and a nitrogen stream 103. The oxygen stream 102 can have very high purity, e.g. 95% and above, and the nitrogen stream 103 can be high purity and a valuable byproduct. An energy stream E1 can be the total energy requirement of the ASU 106. The energy demand of this separation in the ASU can be high, e.g. 6-8% of the total energy production of the system 100.

The oxygen 102, a fuel stream 105, and a carbon dioxide recycle stream 126 are delivered to and oxy-fuel combusted in a gas turbine 108.

In the example illustrated, the fuel 105 is burned in the gas turbine 108 and expanded and the recycle stream 126 can be used to control the high temperatures of oxy-combustion. A mass ratio between the recycle stream 126 and the oxygen and fuel flows 102, 105 can be in the range of 2-10 times. The gas turbine 108 turns the generator (not shown) that produces electricity. An energy stream E2 can be the total energy production from the gas turbine 108. The gas turbine 108 can operate at a range of rpms, including 3600 and higher.

In the example illustrated, turbine exhaust 109 is directed to a boiler 110, and supercritical steam is generated at 115. The closed loop can use a steam turbine 111 to generate electricity. An energy stream E3 can be the total energy production from the steam turbine 111. A stream 114 is directed back to the boiler 110. The closed loop can include a steam condenser to change the steam back into water and a pump to recirculate the water. Pressures in the range of 30-70 bar can be used in this closed loop.

In the example illustrated, cooled exhaust gases 113 are condensed in an air- or water-cooled condenser 112. A stream 121 is then delivered to a separator 116, where it is separated into a liquid, water-rich stream 123 that can be used in the condenser 112, and a gaseous, carbon dioxide-rich stream 122. The stream 122 can be divided at 176 into the recycle stream 126 for the gas turbine 108 and a compression and storage/pipelined stream 127. The pipeline stream 127 can be further purified in an amine absorber (not shown), resulting in very pure carbon dioxide (e.g. above 99.5%).

The recycle stream 126 can reduce the oxy-combustion temperatures in the gas turbine 108, and thus carbon dioxide can be an important working fluid. In some examples, a mixture of carbon dioxide and water can be used, where the exhaust stream 113 is cooled and divided into a recycle and another stream to be separated with the same approach.

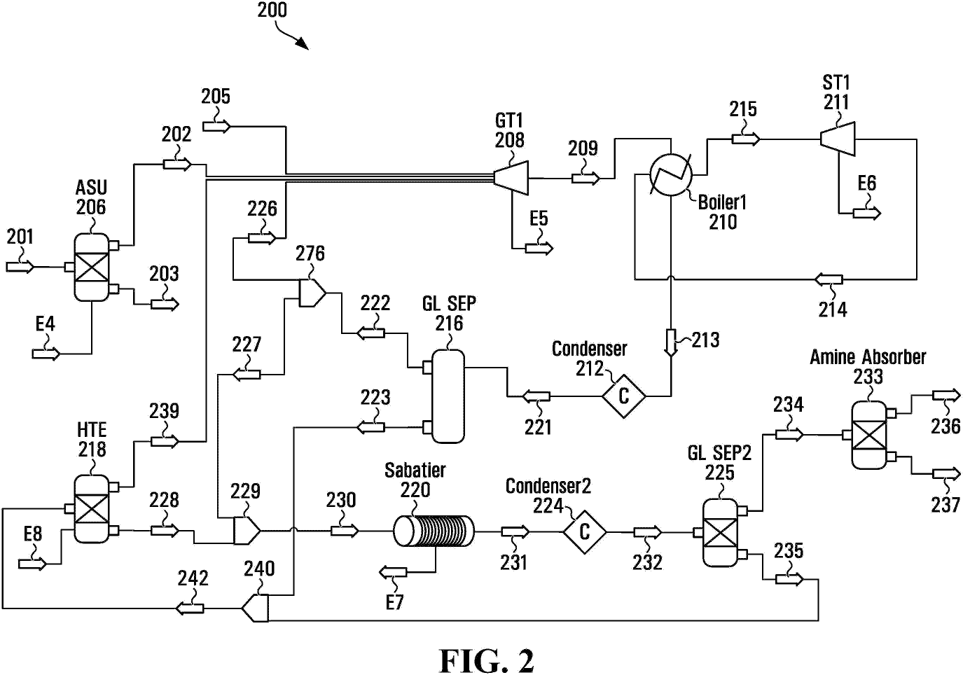

Referring to FIG. 2, a power generation system is shown generally at reference numeral 200. The system 200 has similarities with the system 100, with like features identified by like reference numerals.

In the example illustrated, pure oxygen can be produced by two sources: an air separation unit (ASU) 206; and a high-temperature steam electrolysis unit (HTE) 218. Atmospheric air 201 enters the ASU 206, which can use cryogenic distillation to generate an oxygen stream 202 and a nitrogen stream 203. An energy stream E4 can be the total energy requirement of the ASU 206. The HTE 218 generates an oxygen stream 239 and a hydrogen stream 228. The hydrogen 228 is used for the carbon capture in this system. An energy stream E8 can be the total energy requirement of the HTE 218.

The oxygen 202, 239, a fuel stream 205, and a recycle stream 226 are delivered to and oxy-fuel combusted in a gas turbine 208. An energy stream E5 can be the total energy production from the gas turbine 208.

In the example illustrated, turbine exhaust 209 is directed to a boiler 210, and supercritical steam is generated at 215. The closed loop can use a steam turbine 211 to generate electricity. An energy stream E6 can be the total energy production from the steam turbine 211. A stream 214 is directed back to the boiler 210.

In the example illustrated, cooled exhaust gases 213 are condensed in a condenser 212. A stream 221 is then delivered to a separator 216, where it is separated into a liquid, water-rich stream 223, and a gaseous, carbon dioxide-rich stream 222. The stream 222 can be divided at 276 into the recycle stream 226 for the gas turbine 208 and a stream 227.

In the example illustrated, carbon dioxide is captured at a Sabatier reactor 220 that uses the carbon dioxide-rich stream 227. Pure hydrogen 228 from the HTE 218 is mixed at 229 to form flow 230, and fed to the Sabatier reactor 220, e.g. at a stoichiometric molar ratio of 4:1 to carbon dioxide. The Sabatier reaction can operate at a temperature range of 300-500° C., pressures in the range 5-10 atm, and over a fixed catalytic bed. The efficiency of Sabatier reaction can be in the 85-95% range over optimized conditions. An energy stream E7 can be the total energy production from the Sabatier reactor 220.

Hydrogen can be produced in the HTE 218 at temperatures in the range of 400-900° C. The thermal loads required can be partially secured via heat integration. Electric efficiency of the process can be found in the range of 80-95%, depending on the conditions. In the system 200, high hydrogen production cost can be greatly reduced by directly using the pure oxygen 239 as a feed to the gas turbine 208, thus reducing the energy requirements of the ASU 206.

In some examples, a Sabatier exit stream 231 can include mainly methane and water, but also low compositions of hydrogen and carbon dioxide. In some examples, the Sabatier main product can be methanol, whereas, in other examples, other hydrocarbons can be produced.

In the example illustrated, the hot Sabatier exit stream 231 is condensed in a second condenser 224. In some examples (not shown), the stream 231 can be used to preheat a flow 242 entering the HTE 218, and then delivered to the condenser 224. A stream 232 is then delivered to a second separator 225, where it is separated into a methane-rich gaseous product 234, and a water-rich liquid product 235. The methane-rich stream 234 can be further purified with an amine absorber 233 to form a methane flow 236 and a waste flow 237. The liquid, water-rich stream 235 is joined with the other water-rich stream 223 at 240 to form the flow 242, which is directed to the HTE 218 for the generation of hydrogen 228 and oxygen 239.

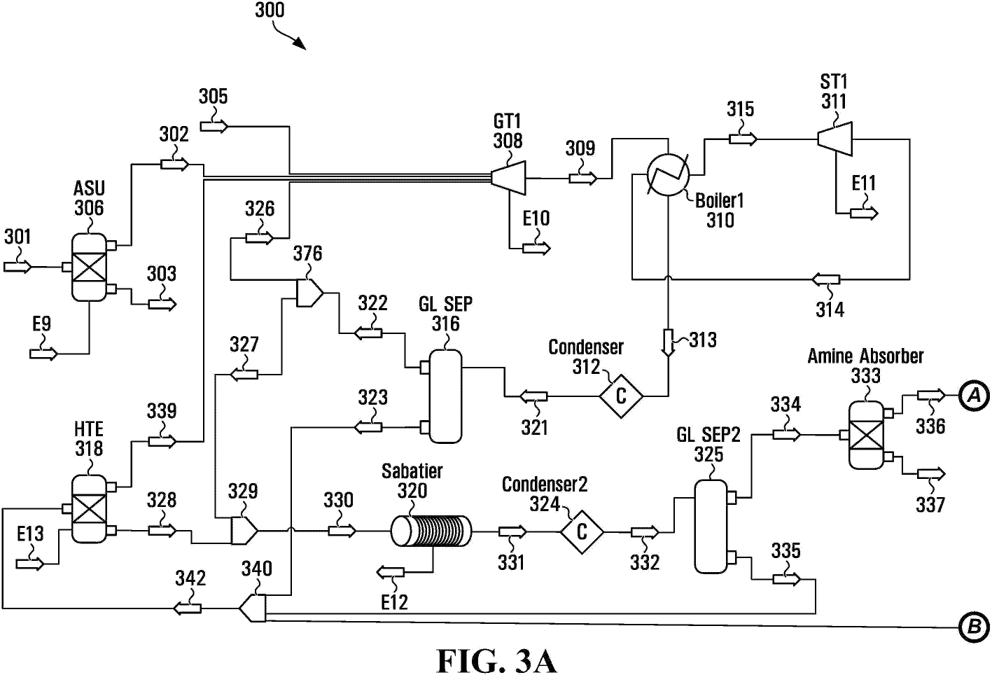

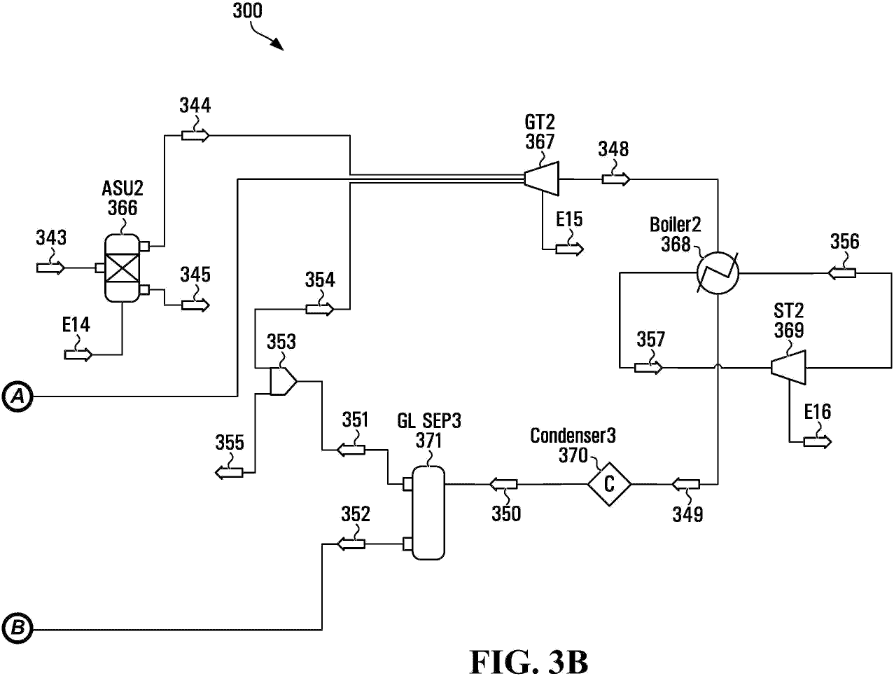

Referring to FIGS. 3A and 3B, a power generation system is shown generally at reference numeral 300. The system 300 has similarities with the systems 100 and 200, with like features identified by like reference numerals.

In the example illustrated, atmospheric air 301 enters an air separation unit (ASU) 306, which can use cryogenic distillation to generate an oxygen stream 302 and a nitrogen stream 303. An energy stream E9 can be the total energy requirement of the ASU 306. A high-temperature steam electrolysis unit (HTE) 318 generates an oxygen stream 339 and a hydrogen stream 328. An energy stream E13 can be the total energy requirement of the HTE 318.

The oxygen 302, 339, a fuel stream 305, and a recycle stream 326 are delivered to and oxy-fuel combusted in a gas turbine 308. An energy stream E10 can be the total energy production from the gas turbine 308.

In the example illustrated, turbine exhaust 309 is directed to a boiler 310, and supercritical steam is generated at 315. The closed loop can use a steam turbine 311 to generate electricity. An energy stream E11 can be the total energy production from the steam turbine 311. A stream 314 is directed back to the boiler 310.

In the example illustrated, cooled exhaust gases 313 are condensed in a condenser 312. A stream 321 is then delivered to a separator 316, where it is separated into a liquid, water-rich stream 323, and a gaseous, carbon dioxide-rich stream 322. The stream 322 can be divided at 376 into the recycle stream 326 for the gas turbine 308 and a stream 327.

In the example illustrated, the stream 327 is mixed with the pure hydrogen 328 at 329 to form flow 330, with is fed to a Sabatier reactor 320. An energy stream E12 can be the total energy production from the Sabatier reactor 320. A hot Sabatier exit stream 331 is condensed in a second condenser 324. In some examples (not shown), the stream 331 can be used to preheat a flow 342 entering the HTE 318, and then delivered to the condenser 324. A stream 332 is then delivered to a second separator 325, where it is separated into a methane-rich gaseous product 334, and a water-rich liquid product 335. The methane-rich stream 334 can be further purified with an amine absorber 333 to form a methane flow 336 and a waste flow 337.

In the example illustrated, the methane produced in the Sabatier reactor 320 is sent to fuel another oxy-combustion cycle. Atmospheric air 343 enters a second air separation unit 366, which can use cryogenic distillation to generate an oxygen stream 344 and a nitrogen stream 345. An energy stream E14 can be the total energy requirement of the ASU 366.

The oxygen 344, the stream 336, and a second recycle stream 354 are delivered to and combusted in a second gas turbine 367. These combustion exhaust gases can enter the gas turbine 367 at temperatures in the range of 1,300-1,400° C., which can lead to higher efficiencies but at a higher design cost. The gas turbine 367 can operate at 3600 rpm and higher, with an adiabatic efficiency of 73-77%. An energy stream E15 can be the total energy production from the gas turbine 367.

In the example illustrated, exhaust gases from the gas turbine 367 are used to power a second supercritical closed loop that generates additional electricity. Turbine exhaust 348 is directed to a second boiler 368. Supercritical steam is generated at 357 and powers a second steam turbine 369. An energy stream E16 can be the total energy production from the steam turbine 369. A stream 356 is directed back to the boiler 368. Pressures in the range of 30-70 bar can be used in this closed loop.

In the example illustrated, cooled exhaust gases 349 are condensed in a third condenser 370. A stream 350 is then delivered to a separator 371, where it is separated into a liquid, water-rich stream 351, and a gaseous, carbon dioxide-rich stream 352. The stream 351 can be divided at 353 into the second recycle stream 354 for the gas turbine 367 and a stream 355.

The liquid water-rich stream 352 is joined with the other water-rich streams 323, 335 at 340 to form the flow 342, which is directed to the HTE 318, which can operate at 400-900° C. and high pressures.

While the above description provides examples of one or more apparatuses or methods, it will be appreciated that other apparatuses or methods may be within the scope of the accompanying claims.

1. (canceled)

2. The system of claim 21, comprising an air separation unit for receiving atmospheric air and generating the first oxygen stream and a nitrogen stream from the atmospheric air.

3. The system of claim 2, wherein the air separation unit uses cryogenic distillation to generate the first oxygen stream and the nitrogen stream.

4. The system of claim 3, comprising:
a boiler for receiving the exhaust stream and generating supercritical steam; and
a steam turbine powered with the steam.

5. The system of claim 4, comprising a condenser for condensing the exhaust stream before the separator.

6. (canceled)

7. (canceled)

8. The system of claim 21, comprising a second separator for separating the exit stream into a methane-rich stream and a second water-rich stream.

9. The system of claim 8, comprising a second condenser for condensing the exit stream before the second separator.

10. The system of claim 9, comprising an amine absorber for purifying the methane-rich stream.

11. The system of claim 10, comprising:
a second air separation unit for receiving atmospheric air and generating a third oxygen stream and a second nitrogen stream;
a second gas turbine for combusting a second input stream to form a second exhaust stream; and
a third separator for separating the second exhaust stream into a third water-rich stream and a second carbon dioxide-rich stream,
wherein at least a portion of the second carbon dioxide-rich stream is divided to form a second recycle stream, and
wherein the methane-rich stream, the third oxygen stream and the second recycle stream are mixed to form the second input stream.

12. The system of claim 11, wherein the second air separation unit uses cryogenic distillation to generate the third oxygen stream and the second nitrogen stream.

13. The system of claim 12, comprising:
a second boiler for receiving the second exhaust stream and generating supercritical steam; and
a second steam turbine powered with the steam.

14. The system of claim 13, comprising a third condenser for condensing the second exhaust stream before the third separator.

15. (canceled)

16. (canceled)

17. The system of claim 11, wherein at least one of the first, second and third water-rich streams is delivered to the electrolysis unit for generating the second oxygen stream and the hydrogen stream.

18. (canceled)

19. A method, comprising:
oxy-fuel combusting a fuel stream, an oxygen stream and a recycle stream to form an exhaust stream;
separating the exhaust stream into a water-rich stream and a carbon dioxide-rich stream;
dividing at least a portion of the carbon dioxide-rich stream to form the recycle stream;
delivering a remaining portion of the carbon dioxide-rich stream and a hydrogen stream to a Sabatier reactor;
generating a second oxygen stream and the hydrogen stream with a high-temperature steam electrolysis unit, and using the second oxygen stream in the step of oxy-fuel combusting;
delivering the water-rich stream to the electrolysis unit for generating the second oxygen stream and the hydrogen stream; and
using the hydrogen stream generated by the electrolysis unit with the Sabatier reactor.

20. A system, comprising:
a gas turbine for oxy-fuel combustion of a fuel stream, an oxygen stream and a recycle stream to form an exhaust stream;
a first separator for separating the exhaust stream into a water-rich stream and a carbon dioxide-rich stream, a first portion of the carbon dioxide-rich stream being divided to form the recycle stream;
a Sabatier reactor for receiving a second portion of the carbon dioxide-rich stream and a hydrogen stream, and generating an exit stream;
a second separator for separating the exit stream into a methane-rich gaseous product and a water-rich liquid product; and
a high-temperature steam electrolysis unit for receiving the water-rich stream from the first separator and the water-rich liquid product from the second separator, and generating a second oxygen stream and the hydrogen stream used by the Sabatier reactor, and the second oxygen stream is delivered to the gas turbine for the oxy-fuel combustion.

21. A system, comprising:
a gas turbine for oxy-fuel combustion of a fuel stream, a first oxygen stream, a second oxygen stream, and a recycle stream to form an exhaust stream and produce an energy stream;
a separator for separating the exhaust stream into a first water-rich stream and a carbon dioxide-rich stream, and at least a portion of the carbon dioxide-rich stream is divided to form the recycle stream;
a high-temperature steam electrolysis unit for receiving at least a portion of the first water-rich stream from the separator and generating the second oxygen stream and a hydrogen stream; and
a Sabatier reactor for receiving a remaining portion of the carbon dioxide-rich stream from the separator and the hydrogen stream from the electrolysis unit, and generating an exit stream.

22. The system of claim 21, wherein the hydrogen stream is produced in the electrolysis unit at a temperature between 400 and 900° C.

23. The system of claim 22, wherein the Sabatier reaction operates at a temperature between 300 and 500° C.

24. The system of claim 23, wherein the Sabatier reaction operates at a pressure in between 5 and 10 atm.
